(19) United States
(12) Patent Application Publication
(10) Pub. No.: US 2010/0281245 A1
(43) Pub. Date: Nov. 4, 2010

(54) METHOD AND APPARATUS FOR TUNING A DIGITAL SYSTEM

(75) Inventors: Francesco Pessolano, Veldhoven (NL); Rinze L.M.P. Meijer, Herkenbosch (NL); Jose De Jesus Pineda De Gyvez, Eindhoven (NL); Marcus J.M. Heijligers, Geldrop (NL)

Correspondence Address: Docket Clerk, P.O. Box 802432, Dallas, TX, 75380, US

(73) Assignee: NXP B.V., Eindhoven (NL)

(21) Appl. No.: 11/813,863

(22) PCT Filed: Jan. 10, 2006
(86) PCT No.: PCT/IB06/50083

§ 371 Date: Jun. 16, 2010

(30) Foreign Application Priority Data
Jan. 12, 2005 (EP) 05100153.5
Jan. 10, 2006 (IB) PCT/IB2006/050083

(51) Int. Cl. G06F 9/00

(52) U.S. Cl. 713/100

(57) ABSTRACT

A digital system 1 comprises receiving means (5) for receiving one or more performance indicators or parameters from software (6) controlling the execution of an application (3). Based on the performance indicators received by the receiving means (5), a tuning circuit (7) is provided for tuning the frequency (f), supply voltage (Vdd) and/or the transistor threshold voltage (Vb) of the digital system (1). In addition, pipeline configuration means (8) are provided for configuring the pipeline of the digital system (1) based on a pipeline depth determined by selecting means (10). The selecting means (10) is configured to select the pipeline depth (Pd) based on the frequency (f), supply voltage (Vdd), transistor threshold voltage (Vb), and according to whether the application requires maximum throughput or minimum latency.

### FIELD OF THE INVENTION

The invention relates to a method and apparatus for tuning the performance of a digital system such as an IP block or a system on chip (SoC), and in particular to a method and apparatus for tuning the performance of a digital system for best execution according to a particular application.

### BACKGROUND OF THE INVENTION

There is a continual drive to improve the hardware design of digital systems to obtain the best possible performance in terms of speed, power consumption, error free operation, and so on. In addition to improving the actual hardware designs of digital systems, there is also a continual drive to improve the performance of any given digital system by changing its operating parameters. For example, it is known to change the operating parameters of digital systems such that they operate at the fastest possible frequency and/or with the lowest possible power consumption, depending on the desired performance for a given application.

Techniques have been developed to adapt the performance of a digital system, for example an isolated IP bock or SoC, such that a certain level of performance is guaranteed both in terms of speed and power in some optimal way depending on a particular application. FIG. 1 shows an example of a known system in which the supply voltage, frequency, and transistor threshold voltages of a digital system can be modified to change the performance of the digital system.

In FIG. 1, the digital system 1 comprises execution means 3 for executing a particular application. The digital system 1 also comprises receiving means 5 for receiving performance indicators or parameters for tuning the digital system 1. For example, the performance indicators may be received in the form of dedicated instructions 6 from the software that controls the execution of the application. Based on the performance indicators received by the receiving means 5, a tuning circuit 7 is provided for tuning the frequency (f), supply voltage (Vdd) and/or the transistor threshold voltage (Vb) of the digital system 1. In this way, the performance indicators communicated by the software 6 have the effect of forcing the hardware to adapt its operating parameters so that the desired performance can be obtained. The desired performance can be specified in many ways, for example by reference to the number of giga operations per second (GOPS); by reference to a maximum power consumption level; or by reference to a desired noise margin or level. The tuning means 7 can then tune the performance of the hardware to obtain the desired performance.

FIG. 2 describes the operation of the software controlling the operation of the digital system of FIG. 1. In step 21 an application is compiled, followed by the step of determining the execution profile of the application, step 23. One or more performance indicators or parameters are then determined, step 25. As mentioned above, a performance indicator can be specified in terms of GOPS, power consumption or noise factor. Based on the performance indicator, the execution of the application is augmented by tuning the parameters of the digital system, step 27. Also as mentioned above, the tuning involves adjusting the frequency (f), supply voltage (Vdd) and/or the transistor threshold voltage (Vb) of the digital system 1.

This technique provides a tuning scheme aimed at optimising the performance of an IP block or SoC in real time. The technique determines the optimal power supply (Vdd), threshold voltage (Vb) and clock frequency (f) for a given desired performance in terms of speed and/or power consumption.

Modern digital systems are also facing more and more problems relating to slow interconnect, excessive power demands and complex system composability. These problems have resulted in the concept of partitioning a digital system into islands (ie a group of IPs), each of which is internally synchronous and independent from the rest of the system. In this way the system becomes asynchronous. The performance of each partition or island can be tuned as mentioned above to provide an optimum performance for a given application. While such techniques are advantageous for achieving the desired performance in terms of speed and/or power consumption, the techniques can have detrimental consequences for data throughput and/or data latency of a digital system.

The aim the present invention is to provide a method and apparatus for tuning the performance of a digital system, without having the disadvantages mentioned above.

### SUMMARY OF THE INVENTION

According to a first aspect of the present invention there is provided a method of tuning the performance of a digital system. The method comprises the steps of receiving one or more performance indicators relating to the performance of the digital system, and tuning the frequency, supply voltage and/or transistor threshold voltage of the digital system to obtain a desired performance. The method also comprises the step of thereafter adjusting the pipeline depth of the digital system to fine tune the performance of the digital system.

The invention has the advantage of being able to provide an initial tuning step in accordance with performance indicators provided to obtain a desired level of performance, with a pipeline depth adjustment provided for fine tuning the performance of the digital system.

According to another aspect of the invention, there is provided an apparatus for tuning the performance of a digital system. The apparatus comprises means for receiving one or more performance indicators relating to the performance of the digital system, and tuning means for tuning the frequency, supply voltage and/or transistor threshold voltage of the digital system to obtain a desired performance. The apparatus also comprises pipeline configuration means for adjusting the pipeline depth of the digital system after the tuning means has tuned the digital system, thereby fine tuning the performance of the digital system.

### BRIEF DESCRIPTION OF THE DRAWINGS

For a better understanding of the present invention, and to show more clearly how it may be carried into effect, reference will now be made, by way of example only, to the following drawings in which:

FIG. 1 is a block diagram of a conventional apparatus for tuning the performance of a digital system;

FIG. 2 is a flow chart describing how the apparatus of FIG. 1 is controlled to tune the performance of a digital system;

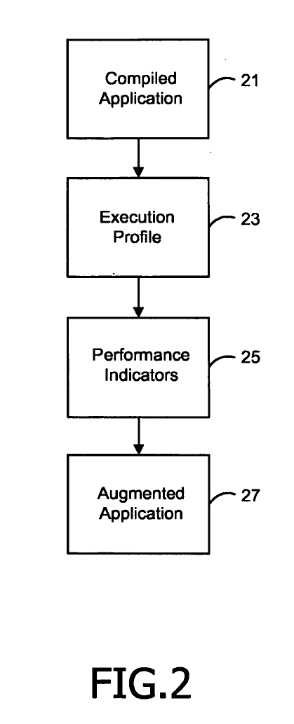

FIG. 3 is a block diagram of an apparatus according to the present invention for tuning the performance of a digital system;

FIG. 4 is a flow chart describing how the apparatus of FIG. 3 is controlled to tune the performance of a digital system in accordance with the present invention;

FIG. 5 is a state diagram describing the operation of the system according to the present invention.

### DETAILED DESCRIPTION OF A PREFERRED EMBODIMENT OF THE INVENTION

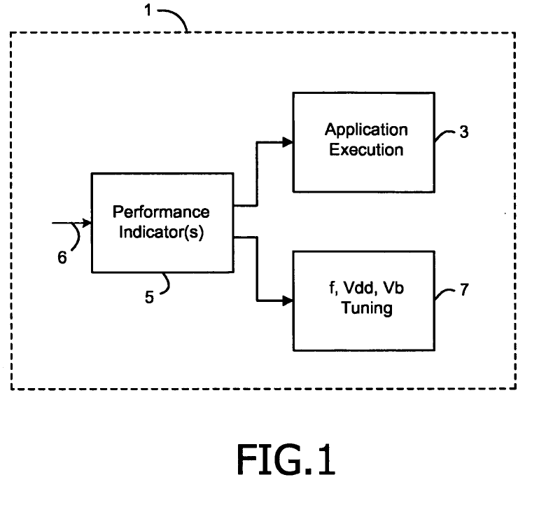

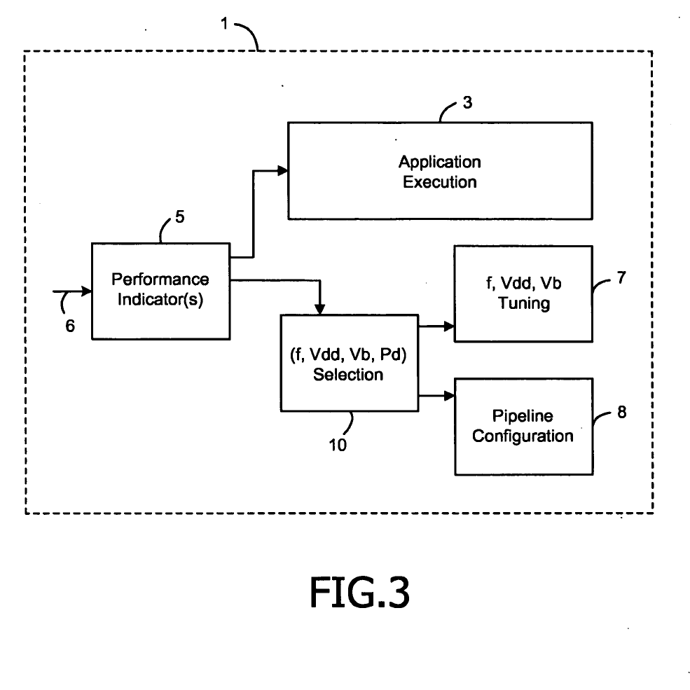

FIG. 3 shows a system according to the present invention. As described above in relation to FIG. 1, the digital system 1 comprises execution means 3 for executing a particular application. The digital system 1 also comprises receiving means 5 for receiving one or more performance indicators or parameters from software 6 for augmenting the performance of the digital system 1. Based on the performance indicators received by the receiving means 5, a tuning circuit 7 is provided for tuning the frequency (f), supply voltage (Vdd) and/or the transistor threshold voltage (Vb) of the digital system 1.

However, in accordance with the present invention, the digital system 1 also comprises pipeline configuration means 8 for configuring the pipeline depth of the digital system 1. The system also comprises selecting means 10 for selecting the frequency (f), supply voltage (Vdd), transistor threshold voltage (Vb) and pipeline depth (Pd) of the digital system being tuned. The selecting means 10 is configured to select the frequency (f), supply voltage (Vdd), transistor threshold voltage (Vb) and pipeline depth (Pd) of the digital system in accordance with the performance indicators received for a given application, as will be described in greater detail below.

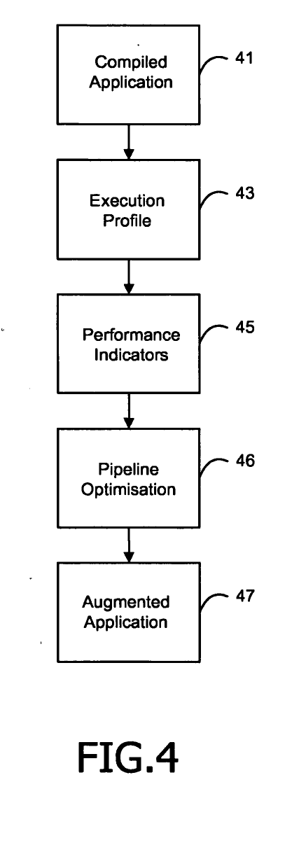

FIG. 4 describes the operation of the software that controls the operation of the digital system of FIG. 3 in accordance with the present invention. In step 41 an application is compiled, followed by the step of determining the execution profile of the application, step 43. One or more performance indicators or parameters are then determined, relating to the desired performance for a given application, step 45. For example, a performance indicator can be specified in terms of GOPS, power consumption or noise factor. The pipeline depth is then configured for a given frequency, so that the throughput or latency can be optimised, step 46. Based on the performance indicator or indicators provided by the software, the execution of the application is augmented by tuning the parameters of the digital system, step 47.

Thus, according to the invention, the tuning involves adjusting the pipeline depth (Pd), in addition to tuning the frequency (f), supply voltage (Vdd) and/or the transistor threshold voltage (Vb) of the digital system 1. In this way the adjustment of the pipeline depth acts as a means of fine tuning the digital system, after the digital system has been tuned in terms of the frequency (f), supply voltage (Vdd) and/or the transistor threshold voltage (Vb).

The selecting means 10 can be configured to determine the best possible pipeline depth for any given frequency in order to optimise throughput, latency, or a compromise or average of throughput and latency. Alternatively, the selecting means 10 can be configured to determine a range of possible pipeline depths for any given frequency. This is because the frequency provides a hard constraint on the pipeline depth in terms of maximum delay between two stages in the pipeline. The power supply (Vdd) and the transistor threshold voltage (Vb) also alter the delay and, in this sense, they also influence this hard constraint. It will be appreciated that this is an upper delay constraint, but smaller delays (corresponding to deeper pipelines) are allowed, and this will depend solely on the performance indicator received from the software.

The selecting means 10 can be configured to determine the pipeline depth on-the-fly. In other words, the selecting means 10 can be configured to dynamically determine the pipeline depth in response to the performance indicator or indicators received from the software. Alternatively, the selecting means 10 can be configured to select a pipeline depth based on pre-calculated values stored in a look-up table. With the latter, the look-up table comprises a list of pipeline depths required to provide a certain throughput or latency for different combinations of frequency (f), supply voltage (Vdd) and/or transistor threshold voltage (Vb).

The step of configuring the pipeline involves changing the depth of the pipeline. The depth of the pipeline can be changed by skipping one or more register banks separating pipeline stages in the digital system. This allows performance to be changed in terms of data throughput or data latency depending on the particular application. As will be appreciated by a person skilled in the art, the throughput of a pipeline is the measure of how often an instruction exits the pipeline, ie the number of instructions completed per second. In contrast, pipeline latency relates to how long it takes to execute a single instruction in the pipeline.

Although it is known to change the depth of a pipeline per se, the depth is normally changed to reduce frequency, which in turn reduces power consumption. This has limited advantages in isolation. The present invention differs in that the system is first tuned in terms of supply voltage (Vdd), frequency (f) and/or transistor threshold voltage (Vb), for example to reduce power consumption, but with a further adjustment made to adjust the pipeline depth. In other words, the tuning of the supply voltage (Vdd), frequency (f) and transistor threshold voltage (Vb) for reduced power consumption will have the side effect of reducing the overall performance of the system, which is then compensated by tuning the pipeline depth to improve performance, ie either for data throughput or data latency optimisation.

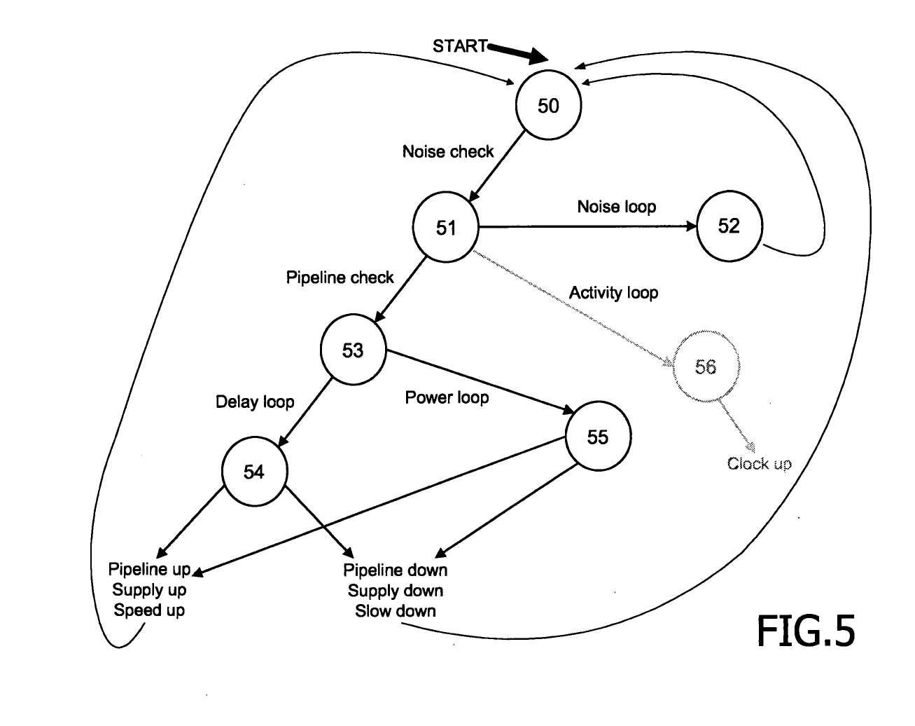

FIG. 5 shows a state diagram describing the operation of the apparatus according to the present invention. The initial state is state 50, that is either when a controller is started or when a controller receives a new performance indicator. At this point the controller moves to state 51, where the controller checks an extracted parameter such as the noise factor to determine if the noise is within given margins. If the noise is not within given margins, the controller will enter a noise loop 56 aimed at reducing the noise to an acceptable level. This is accomplished by a fine grain change in supply voltage (Vdd), transistor threshold voltage (Vb) and/or supply frequency (f).

If the noise is below the maximum level, the controller moves to state 53, where a pipeline check is performed. Here the performance indicator is translated into the triple (pipeline depth, frequency, supply) which minimises power and is easier to reach (local maximum with minimum state distance where locality is determined by the delay in the changes of supply and frequency and a design constraint on how long it should take to reach the new triple). The triple is then imposed on the system by means of the delay loop (54) and supply loop (55). These loops are not independent as there is an order in which the pipeline depth, supply voltage and clock frequency must be changed. For example, preferably the frequency should not be increased until the power supply has been increased. Also, a decrease in power supply should preferably be preceded by a frequency decrease. It will be appreciated that the change in transistor threshold voltage (Vb) can be hidden in the power, speed and noise actions.

The controller is such that, even without changing the performance indicator, it might change the triple (pipeline depth, frequency, supply) due to the fact that it always pursues a constrained local minimum. This may occur, for example, when the values of power supply (Vdd), frequency (f), transistor threshold voltage (Vb) and pipeline depth (Pd) are changed because of changes in environmental conditions, such as temperature.

Although the preferred embodiment refers to the digital system being an IP block or SoC, it will be appreciated that the digital system may be any form of integrated circuit, including integrated circuits partitioned into separate regions or islands.

Furthermore, although the performance indicators are described as being communicated from the software to the hardware in the form of dedicated instructions, it will be appreciated that the performance indicators can be provided in other ways.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfill the functions of several units recited in the claims. Any reference signs in the claims shall not be construed so as to limit their scope.

1. A method of tuning the performance of a digital system, the method comprising the steps of: receiving one or more performance indicators relating to the performance of the digital system;—tuning the frequency, supply voltage and/or transistor threshold voltage of the digital system to obtain a desired performance; and thereafter adjusting the pipeline depth of the digital system to fine tune the performance of the digital system.

2. A method as claimed in claim 1, wherein prior to the step of adjusting the pipeline depth there is the step of determining an optimum pipeline depth for a given frequency.

3. A method as claimed in claim 2, wherein the step of determining the optimum pipeline depth is based on achieving maximum throughput in the digital system.

4. A method as claimed in claim 2, wherein the step of determining the optimum pipeline depth is based on achieving the minimum latency in the digital system.

5. A method as claimed in claim 2, wherein the step of determining the optimum pipeline depth is based on achieving a compromise between throughput and latency in the digital system.

6. A method as claimed in claim 1, wherein the step of adjusting the pipeline depth comprises the step of skipping one or more register banks separating different pipeline stages in the digital system.

7. A method as claimed in claim 1, wherein different parts of the digital system are tuned according to different performance indicators.

8. A method as claimed in claim 1, wherein the digital system is an IP block or SoC.

9. Apparatus for tuning the performance of a digital system, the apparatus comprising: means for receiving one or more performance indicators relating to the performance of the digital system; tuning means for tuning the frequency, supply voltage and/or transistor threshold voltage of the digital system to obtain a desired performance; and pipeline configuration means for adjusting the pipeline depth of the digital system after the tuning means has tuned the digital system, thereby fine tuning the performance of the digital system.

10. Apparatus as claimed in claim 9, further comprising selecting means for selecting an optimum pipeline depth for obtaining the desired performance.

11. Apparatus as claimed in claim 10, wherein the selecting means is configured to select an optimum pipeline depth for achieving maximum throughput in the digital system.

12. Apparatus as claimed in claim 10, wherein the selecting means is configured to select an optimum pipeline depth for achieving minimum latency in the digital system.

13. Apparatus as claimed in claim 10, wherein the selecting means is configured to select an optimum pipeline depth for achieving a compromise between throughput and latency in the digital system.

14. Apparatus as claimed in claim 9, wherein the pipeline configuration means for adjusting the pipeline depth comprises means for skipping one or more register banks separating different pipeline stages in the digital system.

15. Apparatus as claimed in claim 9, wherein different parts of the digital system are configured to be tuned according to different performance indicators.

16. Apparatus as claimed in claim 9, wherein the digital system is an IP block or SoC.
